(19) United States
(12) Patent Application Publication
(10) Pub. No.: US 2006/0185980 A1
(43) Pub. Date: Aug. 24, 2006

(54) Ceramic sensor and manufacturing method thereof

(76) Inventor: Hiroshi Fukuda, Tokyo (JP)

Correspondence Address: REED SMITH LLP, Suite 1400, 3110 Fairview Park Drive, Falls Church, VA, 22042, US

(21) Appl. No.: 11/202,267

(22) Filed: Aug. 12, 2005

(30) Foreign Application Priority Data
Feb. 18, 2005 (JP) 2005-041537

(51) Int. Cl. G01N 27/26

(52) U.S. Cl. 204/431

(57) ABSTRACT

The compatibility of increased sensitivity with both reliability and durability was difficult, since in a gas sensor composed of polycrystalline grains or ceramic particles, there is a trade-off relationship between increasing sensitivity through particle size reduction and change with time due to grain growth. Moreover, it was difficult to integrate a ceramic sensor with high sensitivity, high durability and high reliability with a Si integrated circuit in the monolith. A gas sensor is composed of an artificial nano-structure ceramic film where a change in the ceramic structure due to grain growth, etc. does not occur because of heat. The ceramic thin film is formed to a pattern shaped template on a nanometer level by using a sol-gel method and cured adequately to form precisely. Moreover, the above-mentioned gas sensor is integrated with an integrated circuit in the monolith.

### CLAIM OF PRIORITY

The present application claims priority from Japanese application JP 2005-041537 filed on Feb. 18, 2005, the content of which is hereby incorporated by reference into this application.

### FIELD OF THE INVENTION

The present invention relates to a gas sensor composed of ceramics. More particularly, it relates to a technology integrating a ceramic sensor and a semiconductor integrated circuit.

### BACKGROUND OF THE INVENTION

In the environment surrounding a variety of industrial fields and daily life, it is very important to detect various gases which are dangerous, harmful to or unpleasant for human body, or which destroy the global environment. Moreover, sensing the concentration of gases is required for controlling an automobile engine. On the other hand, attempts to diagnose the health condition of the human body using gases have been reported. A ceramic gas sensor is one of the typical methods for sensing gas concentration. This sensor uses the change in electrical resistance of ceramics due to gas concentration, and it has the feature that it is relatively portable and low in cost as compared to other methods.

For instance, in the ceramic gas sensors used in automobile engines, paste ceramics are coated on a substrate forming electrodes on the surface, cured at a high temperature, and a ceramic film with a thickness from ten to several tens of micrometers is formed. When the concentration of a gas is detected, the resistance between the electrodes is measured after heating the film from 200° C. to 300° C. Tin oxide (SuO), zinc oxide (ZnO), and tungsten oxide (WO) are the typical ceramics used.

Various experiments have been made with the ceramic gas sensor with the goal of increasing the ceramic sensor sensitivity (for instance, refer to Proceedings of the 1^{st} AIST International Workshop for Chemical Sensors, National Institute of Advanced Industrial Science and Technology, published by Synergy Materials Research Center, Mar. 13, 2003, pp. 3-11). For instance, if the grain size of the poly-crystal is reduced, the surface-to-total volume ratio (accordingly, the depletion layer volume) increases, so that the rate of resistance change increases. The sol-gel method is discussed as a method for forming the ceramic film instead of the paste. Since ceramic particles with a diameter from several micrometers to several nanometers are formed in the sol-gel method, the method is effective as one of the techniques for making the above-mentioned poly-crystalline grains smaller. Moreover, there is a report where fiber ceramics have been formed and applied as gas sensors.

In addition to a ceramic film, a heater with temperature control to warm it, and a resistance measurement function are required for a ceramic gas sensor. Moreover, signal processing and analysis from a plurality of sensor outputs are preferably necessary. In the prior art, there have been attempts to integrate a ceramic film, a heater, and an integrated circuit in the monolith (on the same substrate). A micro heater has been developed on which a heater circuit and a temperature sensor using the temperature dependence of metallic resistance are provided on a thin insulator film membrane by using a so-called MEMS technology (for instance, refer to Specification of U.S. Pat. No. 5,830,372, and Wada, “Special Edition, Heat Radiation Analysis of Bridge-type Micro-heaters”, DENSO technical review, DENSO Ltd., Vol. 5, June 2000, pp. 51-55).

### SUMMARY OF THE INVENTION

The most simplified principle of operation of a ceramic sensor will be described with reference to FIG. 11. These ceramics consist of poly crystals of a semiconductor material, and a gap exists between the grain boundaries. If air goes into the gap, oxygen molecules in the air are decomposed at the polycrystalline grain surface and adsorbed as oxygen atoms. Since oxygen atoms with high electron affinity attract electrons from inside the ceramics, a depletion layer is formed at the surface of the ceramic polycrystalline grain, and the number of carriers (electrons) contributing to the electrical conduction in the ceramics decreases. Thus, when reducing gas molecules penetrate, surface-adsorbed oxygen molecules are bonded thereto, and the electrons are returned to the ceramic side, thereby the number of carriers inside the ceramic increases and the electrical resistance decreases. By detecting the change in this electrical resistance, one can detect the gas.

Since the thickness of the depletion layer formed on the surface of the ceramic poly crystalline grain is constant, the smaller the crystal grain is, the larger is the change of the electric resistance caused by the presence of the reducing gas molecule, and better is the sensitivity as a gas sensor. Moreover, it is also possible to measure the concentration of many kinds of gases using different kinds of ceramic sensors or to distinguish the kind of gas, since the rate of resistance change differs for a variety of ceramic materials different according to the kind of gas.

However, in ceramics used for gas sensors, grain growth of the poly crystalline grains or particles is caused, in general, by thermal energy, etc. The above-mentioned grain growth occurs more readily the smaller the diameter of the poly crystalline grains or particles becomes, and, as a result, the sensor characteristics change. On the other hand, in order to increase the sensitivity of the gas sensor it is preferable to reduce the diameter of the poly crystalline grain or the particle as previously mentioned. Therefore, a trade-off relationship is created between sensitivity and long-term stability (durability). Moreover, the processing of a ceramic film is, in general, difficult, and it is difficult to integrate the above-mentioned Si integrated circuit in the monolith.

It is an objective of the present invention to provide a ceramic sensor with high sensitivity, and high durability. Specifically, it is an objective of the present invention to provide a ceramic sensor easy to process and capable of integrating in monolithic with an integrated circuit.

The present invention constitutes a sensor film using a plurality of rectangular-shaped ceramic structures which lie along a first direction and is arranged along a direction intersecting said first direction, a plurality of ceramic structures are formed having a predetermined spacing, and the spacing is made on a nanometer level. Moreover, according to the present invention, a patterned ceramic thin film with dimensions on the nanometer level is fabricated by forming a ceramic thin film using a sol-gel method on a template which is processed beforehand in a pattern-shape with dimensions on a nanometer level. Moreover, this invention integrates in the monolith a ceramic gas sensor having an artificial nano-structure with an integrated circuit.

### BRIEF DESCRIPTION OF THE DRAWINGS

FIG. 1A is a schematic diagram of the manufacturing process of a gas sensor according to the one embodiment of the present invention;

FIG. 1B is a schematic diagram of the manufacturing process of a gas sensor according to the one embodiment of the present invention;

FIG. 1C is a schematic diagram of the manufacturing process of a gas sensor according to the one embodiment of the present invention;

FIG. 1D is a schematic diagram of the manufacturing process of a gas sensor according to the one embodiment of the present invention;

FIG. 1E is a schematic diagram of the manufacturing process of a gas sensor according to the one embodiment of the present invention;

FIG. 1F is a schematic diagram of the manufacturing process of a gas sensor according to the one embodiment of the present invention;

FIG. 2A is a plane circuit diagram of each layer that composes a gas sensor according to the one embodiment of the present invention;

FIG. 2B is a plane circuit diagram of each layer that composes a gas sensor according to the one embodiment of the present invention;

FIG. 2C is a plane circuit diagram of each layer that composes a gas sensor according to the one embodiment of the present invention;

FIG. 2D is a plane circuit diagram of each layer that composes a gas sensor according to the one embodiment of the present invention;

FIG. 3 is a bird's eye view of the ceramics portion and the structure of the sensor electrode portion of a gas sensor according to one embodiment of the present invention;

FIG. 4A is a schematic diagram illustrating one part of the manufacturing process of a gas sensor according to an improvement of one embodiment of the present invention;

FIG. 4B is a schematic diagram illustrating one part of the manufacturing process of a gas sensor according to an improvement of one embodiment of the present invention;

FIG. 4C is a schematic diagram illustrating one part of the manufacturing process of a gas sensor according to an improvement of one embodiment of the present invention;

FIG. 4D is a schematic diagram illustrating one part of the manufacturing process of a gas sensor according to an improvement of one embodiment of the present invention;

FIG. 5 is a schematic diagram illustrating a plane structure of the ceramic pattern of a gas sensor according to an improvement of one embodiment of the present invention;

FIG. 6 is a schematic bird's eye view of a gas sensor ceramics portion and the structure of the sensor electrode portion of a gas sensor according to an improvement of one embodiment of the present invention;

FIG. 7A is a schematic diagram illustrating the manufacturing process of an integrated gas sensor that integrates the sensor and an integrated circuit in the monolith according to another embodiment of the present invention;

FIG. 7B is a schematic diagram illustrating the manufacturing process of an integrated gas sensor that integrates the sensor and an integrated circuit in the monolith according to another embodiment of the present invention;

FIG. 7C is a schematic diagram illustrating the manufacturing process of an integrated gas sensor that integrates the sensor and an integrated circuit in the monolith according to another embodiment of the present invention;

FIG. 7D is a schematic diagram illustrating the manufacturing process of an integrated gas sensor that integrates the sensor and an integrated circuit in the monolith according to another embodiment of the present invention;

FIG. 7E is a schematic diagram illustrating the manufacturing process of an integrated gas sensor that integrates the sensor and an integrated circuit in the monolith according to another embodiment of the present invention;

FIG. 7F is a schematic diagram illustrating the manufacturing process of an integrated gas sensor that integrates the sensor and an integrated circuit in the monolith according to another embodiment of the present invention;

FIG. 8A is a schematic diagram illustrating the manufacturing process of an integrated gas sensor that integrates the sensor and an integrated circuit in the monolith according to another embodiment of the present invention;

FIG. 8B is a schematic diagram illustrating the manufacturing process of an integrated gas sensor that integrates the sensor and an integrated circuit in the monolith according to another embodiment of the present invention;

FIG. 8C is a schematic diagram illustrating the manufacturing process of an integrated gas sensor that integrates the sensor and an integrated circuit in the monolith according to another embodiment of the present invention;

FIG. 8D is a schematic diagram illustrating the manufacturing process of an integrated gas sensor that integrates the sensor and an integrated circuit in the monolith according to another embodiment of the present invention;

FIG. 8E is a schematic diagram illustrating the manufacturing process of an integrated gas sensor that integrates the sensor and an integrated circuit in the monolith according to another embodiment of the present invention;

FIG. 8F is a schematic diagram illustrating the manufacturing process of an integrated gas sensor that integrates the sensor and an integrated circuit in the monolith according to another embodiment of the present invention;

FIG. 9A is a schematic diagram illustrating the manufacturing process of an integrated gas sensor that integrates the sensor and an integrated circuit in the monolith according to another embodiment of the present invention;

FIG. 9B is a schematic diagram illustrating the manufacturing process of an integrated gas sensor that integrates the sensor and an integrated circuit in the monolith according to another embodiment of the present invention;

FIG. 9C is a schematic diagram illustrating the manufacturing process of an integrated gas sensor that integrates the sensor and an integrated circuit in the monolith according to another embodiment of the present invention;

FIG. 9D is a schematic diagram illustrating the manufacturing process of an integrated gas sensor that integrates the sensor and an integrated circuit in the monolith according to another embodiment of the present invention;

FIG. 10 is a schematic bird's eye view of an integrated gas sensor according to another embodiment of the present invention;

FIG. 11 is a schematic diagram illustrating the principle of operation of a conventional ceramic gas sensor; and

FIG. 12 is a schematic diagram illustrating the principle of operation of a ceramic gas sensor according to the present invention.

### DETAILED DESCRIPTION OF THE PREFERRED EMBODIMENTS

According to the present invention a ceramic gas sensor with high sensitivity and high reliability can be achieved with a sufficiently high productivity.

### First Embodiment

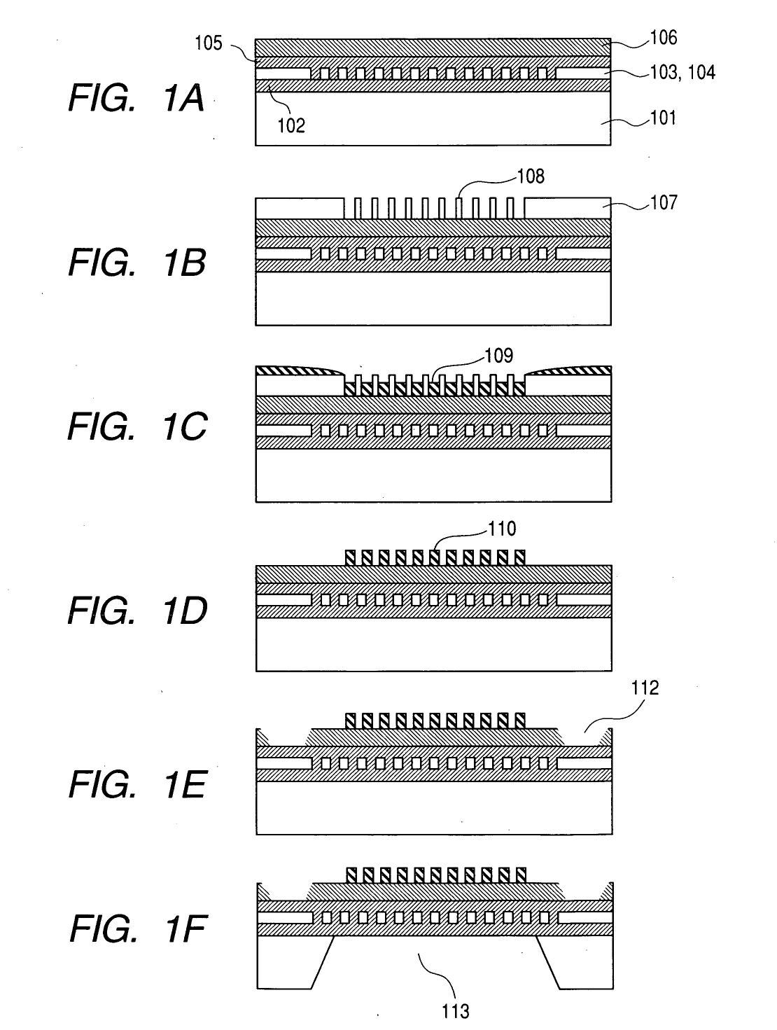

FIGS. 1A to 1F display schematic drawings illustrating a manufacturing process according to this embodiment using the cross-sections of the sensor. First of all, as shown in FIG. 1A, after a silicon oxide film 102 is formed on the surface of a Si substrate 101, for instance, by patterning a poly crystalline silicon thin film using a conventional lithography means with ultraviolet exposure through a mask, a heater circuit 103 and a temperature sensor circuit 104 are formed on the predetermined sensor area. Afterwards, the entire body mentioned above is coated with a Si oxide film 105 and Si nitride film 106.

Next, as shown in FIG. 1B, after a 150 nm thick Si oxide film 107 is deposited as a base film to form a ceramic pattern, a predetermined anti-reflection coating film and a resist film are coated, and a resist pattern having 60 nm of line-and-space is formed by exposing and developing it using ArF reduction projection exposure equipment with the numerical aperture of 0.8 and an alternating-type phase shifting mask. Herein, the line-and space means arranging the 60 nm wide pattern (line) pair in a stripe-shape having a spacing (space) of 60 nm.

The resist pattern is transferred to the above-mentioned Si oxide film by etching the above-mentioned Si oxide film 107 using the above-mentioned resist pattern as a mask to form the Si oxide film pattern 108 having a spatial period of 120 nm and a width of 60 nm. The above-mentioned stripe-shaped Si oxide pattern 108 is formed only in the aforementioned sensor region, and the other area is covered with a uniform oxide film.

Next, as shown in FIG. 1C, an organometallic complex solution (for instance, a metalalkoxide of tin, zinc, and tungsten, etc. and tin naphthenate, etc.) is spin-coated as a ceramic precursor under a condition where the film thickness relative to a flat surface becomes 50 nm, resulting in the above-mentioned ceramic precursor 109 being poured between the stripe-shaped patterns of the above-mentioned Si oxide film. Afterwards, a first heat treatment is performed to gel the ceramic precursor 109.

Next, as shown in FIG. 1D, the gel over the oxide film 107 is removed by polishing the surface of the above-mentioned surface of the substrate. Then, the above-mentioned gel is cured at a high temperature to make ceramics by a second heat treatment. Herein, the high temperature curing is performed at 800° C. Then, the above-mentioned Si oxide film 107 is removed by etching, using diluted hydrofluoric acid, thereby forming the stripe-shaped ceramic pattern 110 on the Si nitride film 106 with a spatial period of 120 nm, a width of 60 nm, and a height of 60 nm.

In this embodiment, the 60 nm wide pattern pairs are arranged with a spacing of 60 nm, but it is expected that the oxide film becomes wider, concretely about 10 nm wider, due to a shift in the horizontal direction during etching of the oxide film, resulting in 70 nm wide Si oxide patterns being formed. Moreover, it is desirable that the width of the ceramic pattern be made as narrow as possible, so that it is preferable that the width of the oxide film pattern (template pattern) be made as wide as possible. Therefore, it is preferable that the width of the resist pattern be wide up to a degree. Moreover, it is preferable that the area density of the ceramic pattern be as high as possible, so that the above-mentioned stripe-shaped spatial period be as small as possible.

Furthermore, in this embodiment, the spacing between the patterns of the Si oxide film, which means the width of the ceramic pattern, is 60 nm. However, it is to be understood that the invention is not intended to be limited to the specific embodiment. Preferably, it is 100 nm or less, and more preferably, it is 30 nm or less. Since the thickness of the depletion layer of the ceramics is several nanometers, the rate of resistance change is several percent or more if the above-mentioned width is 100 nm or less.

Next, as shown in FIG. 1E, a pair of sensor electrodes 111 (not shown in FIG. 1) and the pick-up circuit are formed on the stripe-shaped pattern of the above-mentioned ceramics, and then the aforementioned heater circuit and pick-up window 112 of the temperature sensor circuit are formed on the Si oxide film 105 and the Si nitride film 106.

Finally, as shown in FIG. 1F, a membrane 113 is formed in the aforementioned sensor region by etching the Si substrate from the rear face of the Si substrate corresponding to the aforementioned sensor region to the surface oxide film. The technology, in which a membrane is formed on the substrate surface by etching the Si substrate from the rear face of the Si substrate to the surface oxide film, is a well-known technology used frequently in the technical field, so-called bulk MEMS. The dimensions processed by this technology are usually several hundreds of micrometers or more, and the precision of the pattern is from several to several tens of micrometers. Moreover, because of the limitation of the wall angle of the etched Si wafer, several hundreds of micrometers are necessary for the spacing between the adjacent patterns.

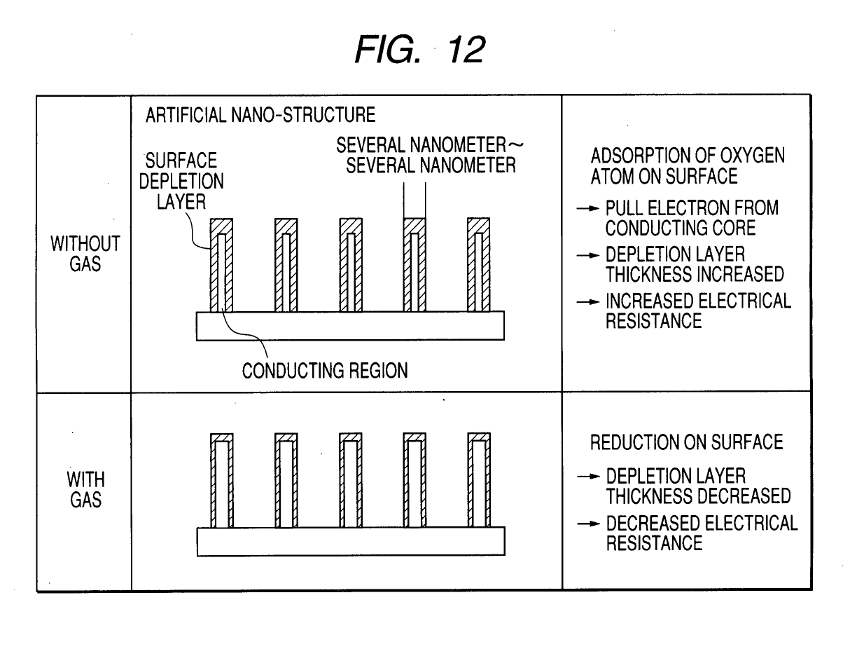

FIG. 12 shows the principle of operation of a ceramic gas sensor formed with a technique of the present invention. The part different from a conventional ceramic gas sensor is only the shape of the ceramic structure, and the basic principle of operation is the same as a conventional one, which is oxygen adsorption and a reduction reaction by gases at the ceramic surface. The gas concentration may be measured by measuring the electrical resistance of a ceramic thin film with a thickness of 100 nm, or preferably 50 nm or less, in lieu of the above-mentioned three-dimensional structure.

Operation of the sensor fabricated by the present invention will be described as follows. The sensor region is controlled to be a desired temperature by increasing the temperature of the sensor region by flowing current to the heater circuit 103, measuring the temperature of the sensor region by detecting the resistance of the temperature sensor circuit 104, and feeding back the measurement results to the heater circuit current value. A well-known means is used for these temperature control circuits. The gas concentration is obtained by measuring the resistance of the stripe-shaped ceramic pattern 110 between the sensor electrodes using the sensor electrodes 111.

In the present invention, the rectangular-shaped ceramic structures are formed having adequate spacing. Therefore, grain growth occurs in the ceramic structures along the direction in which the ceramic structures are lying due to thermal energy from the high temperature curing while forming the ceramics, so that grain growth along the direction intersecting the direction where the structures are lying caused by the structures being connected to each other can be prevented. As a result, making a ceramic sensor with high sensitivity can be achieved. Moreover, since the ceramic structure can be made dense by the high temperature curing during fabrication, crystalline grain growth does not occur easily even if the thermal load is applied by a heater while using it, resulting in the long-term stability and the durability being maintained.

Moreover, ceramics, which are generally difficult to process, can be patterned on the dimensions of a nanometer level without using special processing equipment by combining a standard LSI manufacturing process with a sol-gel method. It becomes possible to improve the sensitivity of a ceramic sensor by forming the structure on the dimensions of a nanometer level. In this embodiment, silicon oxide films were used to form the base film. However, it is to be understood that the invention is not intended to be limited to these, and any film can be used, if it can accept the etching selection ratio between the ceramic and the base film.

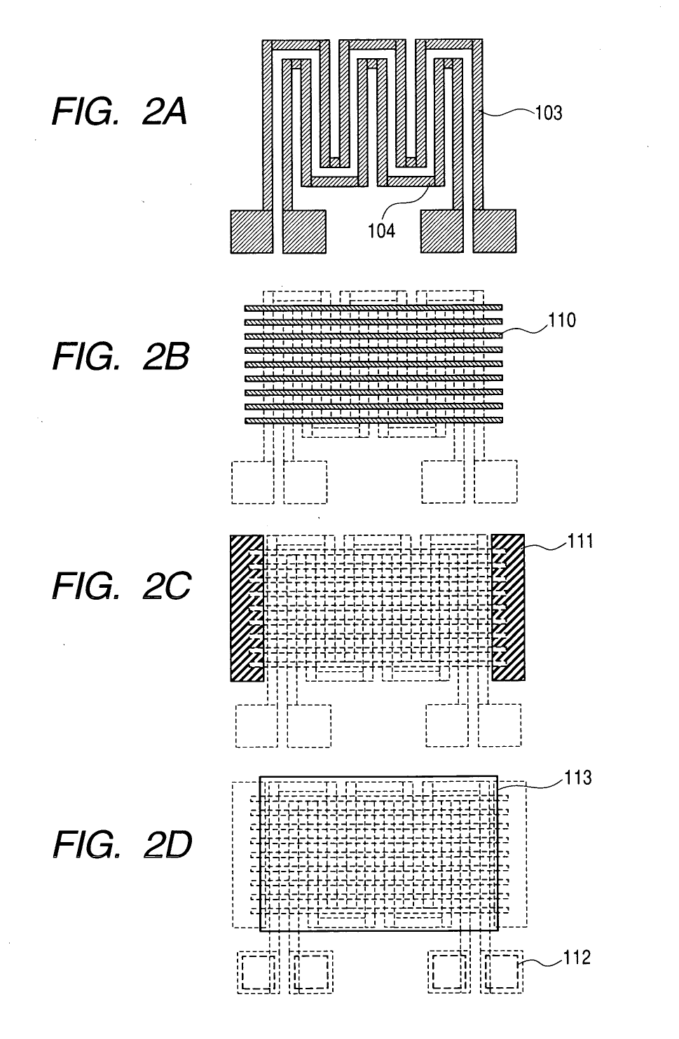

FIGS. 2A to 2D are plane schematic drawings illustrating patterns at several layers of the stacked layer structure shown in FIG. 1. FIG. 2A is a pattern of the heater circuit 103 and the temperature sensor circuit 104. FIG. 2B is the stripe-shaped ceramic pattern 110. FIG. 2C is the pattern of the sensor electrodes 111. FIG. 2D is the pattern of the aforementioned heater circuit, pick-up window 112 of the thermal sensor circuit, and the membrane 113 region.

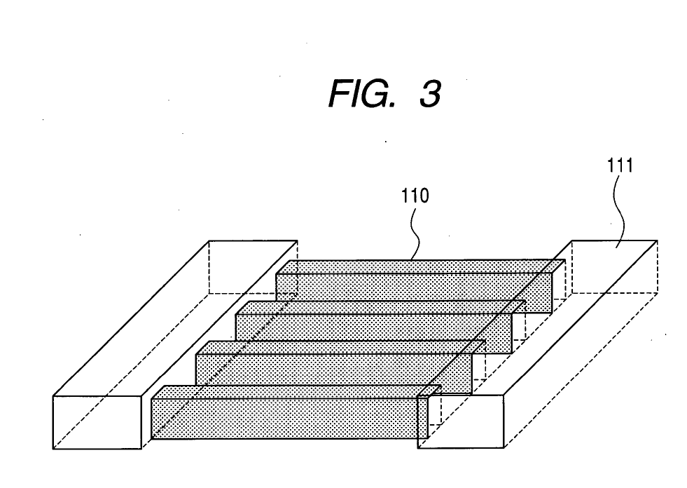

FIG. 3 is a schematic bird's eye view illustrating a structure of the ceramic and the sensor electrode portion formed as above. In a ceramic sensor of the present invention, ceramics having a width on the order of nanometers are arranged in a striped shape and the sensor electrodes are arranged at both ends of the ceramics in a direction intersecting the direction along which the ceramics are lying.

A method for forming a ceramic pattern using the alternating-type phase shifting mask was described in FIG. 1. However, it is not intended to be limited to the above-mentioned method, and various lithography techniques can be applied for the patterning method of the ceramic pattern.

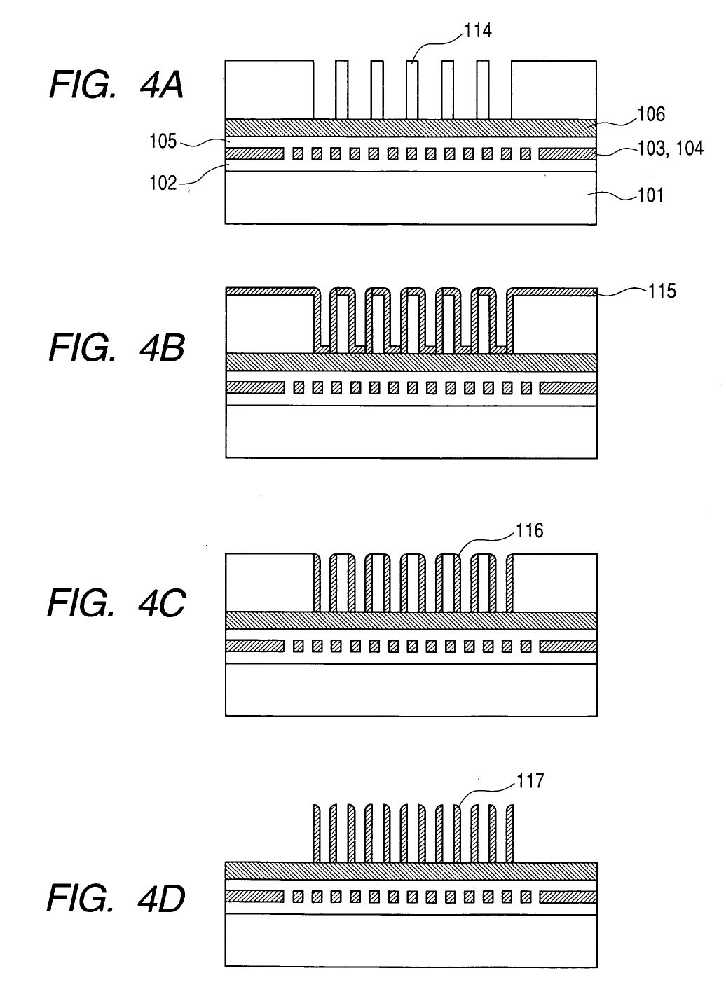

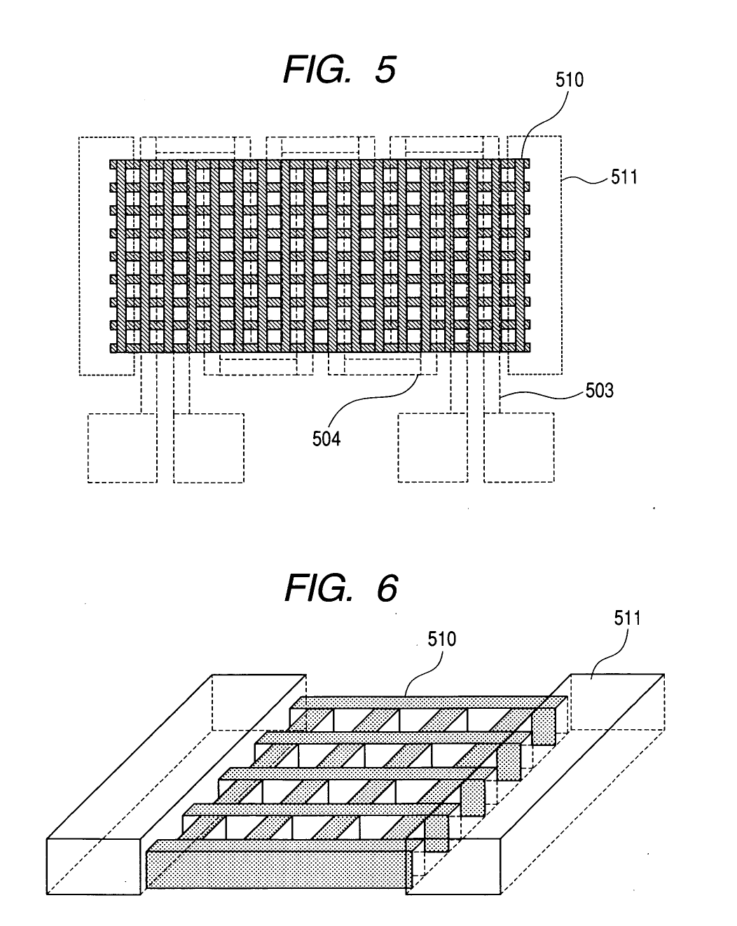

A method for forming the ceramic pattern using the side wall fabricated using the poly Si pattern will be described with reference to FIGS. 4A to 4D. First of all, as shown in FIG. 4A, after forming the Si oxide film 102 on the surface of the Si substrate 101, for instance, by patterning the poly Si thin film using a conventional lithography means with ultraviolet exposure through a mask, the heater circuit 103 and the temperature sensor circuit 104 are formed on the predetermined sensor region. Afterwards, the entire body mentioned above is coated with a Si oxide film 105 and a Si nitride film 106. This process is the same as FIG. 1A of the first embodiment.

Next, after a 150 nm thick poly Si oxide film 114 is deposited on the Si nitride film 106, a resist pattern having 60 nm of line-and-space (striped structure) is formed by using the ArF exposure technique which is the same as the one explained in FIG. 1B of the first embodiment, and the poly Si film is etched using the above-mentioned resist pattern as a mask. According to the dimensional shift during etching, the poly Si pattern 114 is formed with a period of 120 nm, that is, every 120 nm a 20 nm wide pattern is formed with a spacing of 100 nm.

Next, as shown in FIG. 4B, the Si oxide film 115 having a film thickness of 40 nm is deposited uniformly and isotropicaly (conformally). Moreover, anisotropic etching is performed to the entire face from the upper side as shown in FIG. 4C to form the 40 nm wide side wall 116 on the side wall of the above-mentioned poly Si pattern. Afterwards, as shown in FIG. 4D, the above-mentioned poly Si is removed by etching. As a result, a width of 40 nm is formed with a period of 60 nm, that is, every 60 nm a 40 nm wide Si oxide film pattern 117 is formed with a spacing of 20 nm.

A ceramic pattern with a pitch length of 60 nm and a width of 20 nm can be formed by applying the process described from FIG. 1C on, to the Si oxide film pattern 117 formed in FIG. 4D. Besides the method described above, an even finer lattice pattern can be formed by using, for instance, an electron beam writing method, thereby making possible a further improvement in the sensitivity. However, there is a problem that the productivity of the electron beam writing method is low.

Using a nano-imprint method likewise makes it possible to fabricate a fine and low-cost pattern. In the case wherein a nano-imprint method is used, it is possible to switch the Si oxide film to a spin-on-glass (SOG) and to pattern the above-mentioned liquid state SOG directly. For instance, a nano-imprint master which has a desired lattice shaped concavo-convex pattern at the surface is pressed on the liquid state SOG film, and, after curing, a fine lattice pattern is formed on the SOG thin film by removing the master. An almost complete Si oxide film can be obtained by curing the SOG, so that it is also applicable to the above-mentioned processes from FIG. 1B on. Using a nano-imprint method finally one can fabricate a stripe-shaped ceramic pattern having, for instance, a width and a pitch length on the level of 10 nm and 20 nm, respectively. The base film may be formed by etching using a conventional resist as a mask which is made by patterning using the nano-imprint method.

In the case wherein this sensor is used alone, the surface of the substrate except for the sensor region can be in any kind of condition. For instance, the entire surface of the substrate may be covered with the ceramic pattern, and it may be in the condition in which the ceramics adhere to the oxide film or the nitride film. In this case, polishing after the first heat treatment is not always necessary. Since the film thickness of the ceramic precursor is lower than the height of the oxide film pattern, a part of the side wall of the oxide film pattern is exposed when the ceramic precursor is filled between the oxide film patterns, thereby, the ceramics on the oxide film pattern are lifted off and removed with the oxide film pattern by etching using hydrofluoric acid, etc.

Moreover, the second heat treatment is not always necessary and the final curing may be done in the first heat treatment. The long-term stability of the ceramic sensor is improved by curing at a higher temperature. In the case wherein curing is performed at 800° C., the average grain size of the ceramic is on the level of several micrometers, which is larger than the dimension in the width direction of the ceramic pattern. Therefore, the grain boundaries exist only along the direction where the pattern is lying. The typical dimension in the length direction of the ceramic portion is from several tens to several hundreds of micrometers, and the number of grain boundaries is from 100 to 1000. Therefore, the electrical resistance due to the grain boundaries is smaller than the resistance of the ceramic body itself, so that there is almost no change in the properties even if some change in the condition of the grain boundaries occurs during use. Moreover, if it is cured at a higher temperature, the grain size becomes larger than the dimension in the length direction of the ceramic portion and the ceramic at the sensor part actually becomes a single crystal, resulting in very stable aging characteristics being obtained.

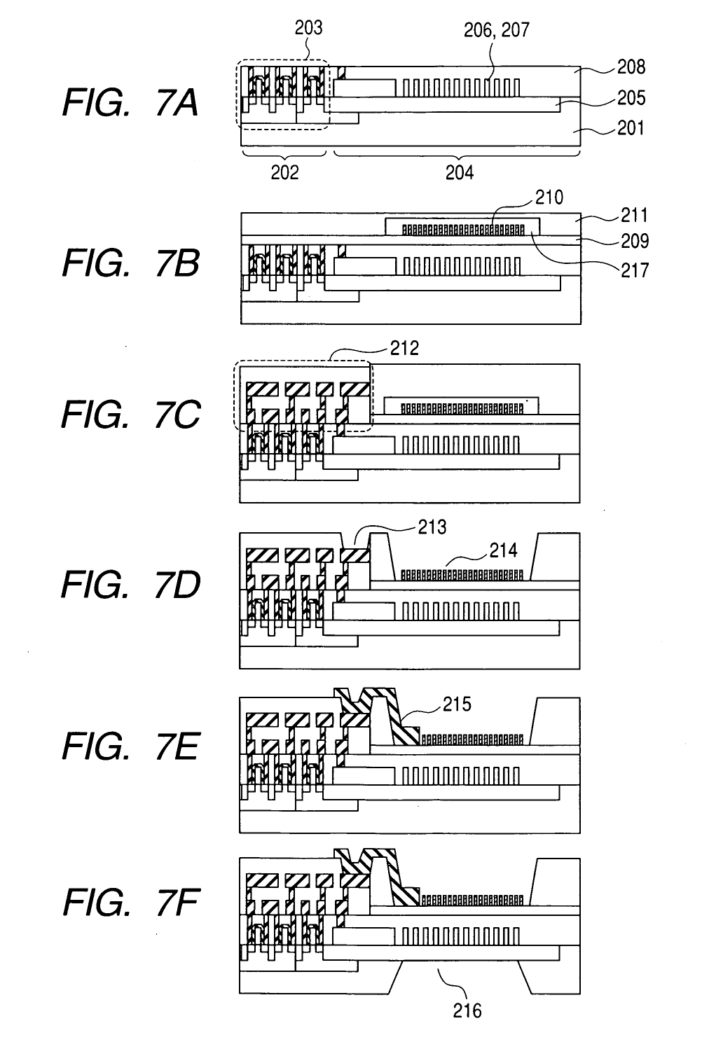

Moreover, in the above explanation, a ceramic pattern is formed in a striped shape, but one can form it in a lattice shape in lieu of a striped shape. FIGS. 5 and 6 show drawings when a ceramic pattern is formed in the shape of a lattice, as seen in a plane view and a bird's eyes view, respectively. In FIG. 5, the lattice-shaped ceramic pattern 510 is formed at the top part of the heater circuit 503 and the temperature sensor circuit 504, and the sensor electrodes 511 are arranged at both ends of the ceramic pattern and are connected to the ceramic pattern.

Moreover, after a plurality of lattice-shaped patterns is stacked sandwiching the oxide thin film, a three-dimensional lattice may be formed by etching, or the like, the oxide film. According to this, the sensitivity of the sensor is further improved due to the two reasons, that is, (1) the current path between the sensor electrodes increases and (2) the surface area of the ceramic around the current path increases. According to the means described above, ceramics, which are generally difficult to process, can be patterned on the dimensions of a nanometer level without using special processing equipment by combining a standard LSI manufacturing process with a sol-gel method.

### Second Embodiment

Next, a method will be described for integrating in the monolith the sensor described in the first embodiment with an integrated circuit. FIGS. 7A to 7F are schematic drawings which illustrate a manufacturing process of an integrated gas sensor in which a sensor described in this embodiment and an integrated circuit are integrated in the monolith. First, as shown in FIG. 7A, an integrated circuit transistor 203 is fabricated by using a conventional CMOS integrated circuit process in a predetermined integrated circuit region 202 on the Si substrate 201. That is, a contact is formed, which consists of a well formation, an isolation by a field oxide film (a trench isolation may be acceptable), a gate oxide film, a gate, a source by a diffusion layer, a drain, and a high-melting point metallic plug. Moreover, herein, a first circuit may be formed to connect the integrated circuit transistor pair, if necessary.

On the other hand, in the predetermined sensor region 204 on the above-mentioned Si substrate, a predetermined oxide film 205 is first formed, and the heater circuit 206 and the temperature sensor circuit 207 are formed on the above-mentioned oxide film by using the poly Si film. Both above-mentioned circuits are extended at both ends to the integrated circuit region so as to connect to the predetermined contact on the poly Si of the above-mentioned integrated circuit.

Next, the oxide film 208 is deposited over the entire area of the above-mentioned substrate. The above-mentioned oxide film 205 is a field oxide film of the above-mentioned transistor; the above-mentioned poly Si film is a gate layer of the above-mentioned transistor; and the above-mentioned oxide film 208 may double as the interpoly dielectric film of the transistor. Then, the entire surface is planarized. Next, as shown in FIG. 7B, the nitride film 209 is deposited on the entire surface, and the ceramic lattice pattern 210 is fabricated thereon, in the above-mentioned sensor region 20, by using a means shown in the first embodiment, and then the above-mentioned ceramic pattern is covered by depositing the oxide layer 217 so as to cover the ceramic lattice pattern 210, and by depositing the nitride film 211 on the entire surface. All processes for forming the ceramic pattern just before coating the ceramic precursor are done in a production line for a CMOS integrated circuit, and the processes thereafter for fabricating the ceramic pattern and the above-mentioned nitride film are accomplished by processing especially intended for the sensor.

Then, after being sufficiently cleaned, the substrate is put back into the production line for a CMOS integrated circuit, and the following processes are performed. First, as shown in FIG. 7C, the above-mentioned nitride film in the integrated circuit region is removed by etching, and the predetermined multi-layer inter-circuit 212 is formed to complete the integrated circuit portion.

As shown in FIG. 7D, an aperture 213 is formed on the pad section in the nitride Si passivation film and the Si oxide film. At this time, the sensor region is covered with the above-mentioned passivation film and the interpoly dielectric film, which was deposited while fabricating the Si nitride film and the multi-layer inter-circuit. Then, the above-mentioned passivation film, the interpoly dielectric film and the nitride film formed on the sensor region are removed, in order, to make the sensor window 214 and to expose the surface of the ceramic pattern.

The following processes are performed in a so-called packaging process (post-processing) line. As shown in FIG. 7E, a pair of sensor electrodes is formed at the ends of the ceramic pattern. Moreover, a circuit 215 is formed which connects the above-mentioned electrodes to a predetermined one selected from the above-mentioned pads. For instance, it is formed by using a resist to form an aperture at a part of the ceramic pattern and the predetermined circuit and by depositing a metal to perform lift-off, etc.

Finally, as shown in FIG. 7F, as in the first embodiment, a membrane 216 is formed in the aforementioned sensor region by etching the Si substrate from the rear face of the Si substrate almost corresponding to the aforementioned sensor region to the surface oxide film. The reason why the membrane is formed is because the substrate of the heater portion has to be made thin in order to reduce the heat capacity.

Thus, scaling down the size and reducing the cost of a sensor system can be achieved by integrating in the monolith a ceramic gas sensor having an artificial nano-structure with an integrated circuit. Moreover, by integrating an analog LSI such as an amplifier in the vicinity of the sensor, noise generated between the sensor and the integrated circuit can be reduced. As a result, increasing the sensitivity of the sensor can be achieved. Furthermore, if an AD converter and micro-computer are integrated on the chip, detecting the gaseous species and monitoring the change with time, etc. become possible, resulting in a chip on which the sensor is mounted being made intelligent.

In order to avoid contamination while forming ceramics using a sol-gel method, fabrication of the transistor is preferably done before fabrication of the ceramic pattern. In this case, the curing temperature of the ceramic is preferably suppressed in the range where the deterioration in the transistor performance does not occur. Moreover, it is preferable that it be lower than the melting point of the high-melting point metal used for the contact. Concretely, it is preferably 800° C. or less.

On the other hand, in the case wherein the integrated circuit region is washed delicately and utmost caution is paid to the above-mentioned contamination after forming the ceramic pattern and passivating using the nitride film, the order may be reversed, that is, the fabrication of the transistor may be done after the fabrication of the ceramic pattern. In this case, since the ceramic can be adequately cured at a high temperature, the long-term stability of the sensor can be further improved.

### Third Embodiment

In an application of a gas sensor, operation for a long period of time without dependence on external energy is often required. For instance, it is necessary to operate it stably for several years using a dry battery. In this case, in addition to the stability of the sensor characteristics themselves, low power consumption is important. Since the power consumption of a ceramic gas sensor is controlled by the heater used to heat the sensor, two points are necessary to make it energy-saving, that is, (1) reducing the heat capacity of the heater and (2) reducing the thermal radiation from the heater portion. Although the priority of the above-mentioned (1) and (2) depends on the operation sequence of the sensor, both (1) and (2) can be achieved by making the heater smaller, in any case.

Concretely, it is necessary to reduce the volume of the heater, the surface area, the contact parts between the heater and the surrounding areas thereof. However, for this purpose, a surface MEMS has an advantage rather than the bulk MEMS shown in the second embodiment. Surface MEMS is the generic name of a technology in which a structure is formed on the surface of a substrate by repeated deposition of a thin film such as one used for a semiconductor integrated circuit, formation of a resist mask by lithography, and etching. Since it uses the same processing technology as a semiconductor integrated circuit, there is a feature that a fine structure can be easily formed compared with the aforementioned bulk MEMS.

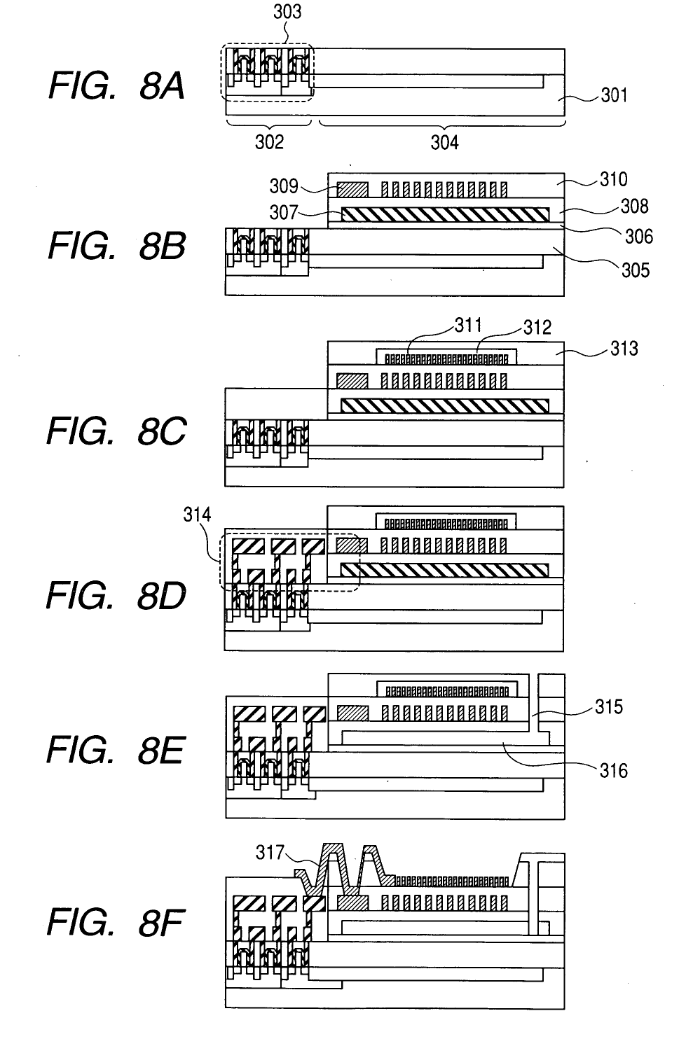

Hereinafter, an example will be described in which a micro-heater by surface MEMS is integrated with a gas sensor according to the first embodiment. FIGS. 8A to 8F are schematic drawings illustrating a manufacturing process of an integrated gas sensor in which a sensor according to this embodiment and an integrated circuit are integrated in the monolith. First of all, as shown in FIG. 8A, an integrated circuit transistor 303 is fabricated by using a conventional CMOS integrated circuit process in a predetermined integrated circuit region 302 on the Si substrate 301. That is, a contact is formed, which consists of a well formation, an isolation by a field oxide film, a gate oxide film, a gate, a source by a diffusion layer, a drain, and a high-melting point metallic plug.

Next, as shown in FIG. 8B, in the predetermined sensor region 304 on the above-mentioned Si substrate, a predetermined oxide film 305 and a nitride film 306 are first deposited, then a sacrificial layer film pattern 307 is formed, and a nitride film 308 is deposited once more on the above-mentioned sacrificial layer film pattern. Moreover, a heater circuit and a temperature sensor circuit 309 are formed on the silicon nitride using an appropriate metallic material, and it is embedded again by a nitride film 310.

Next, as shown in FIG. 8C, a ceramic lattice pattern 311 is formed in the above-mentioned sensor region by using a means described in the first embodiment, and then an oxide film 312 (and a nitride film 313 if necessary) is deposited on the entire surface to cover the above-mentioned ceramic pattern. Next, as shown in FIG. 8D, the nitride film and the oxide film in the integrated circuit region are removed by etching, and then the predetermined multi-layer inter-circuit 314 is formed to complete the integrated circuit portion.

Afterwards, as shown in FIG. 8E, an aperture 315 passing through to the above-mentioned sacrificial layer film pattern from the surface of this substrate is formed, and a cavity 316 is formed by performing etching-removal on the above-mentioned sacrificial layer film through the above-mentioned aperture.

Finally, as shown in FIG. 8F, a silicon oxide film is deposited on the entire surface by a CVD technique to fill the above-mentioned aperture 315, resulting in the above-mentioned cavity 316 being passivated. However, the passivation of the above-mentioned cavity is not necessary. The heat loss is slightly reduced if the cavity is made a vacuum. Moreover, the above-mentioned oxide film on the ceramic pattern and on the circuit pad is removed. Finally, a pair of sensor electrodes is formed at the ends of the ceramic pattern. Moreover, a circuit 317 which connects the above-mentioned electrodes to a predetermined one selected from the above-mentioned pads is formed, and the region except for the sensor is covered with a passivation film (not shown in the figure).

In the case wherein the curing temperature is low, the formation of the ceramic film can take place after the formation of the circuit of the integrated circuit. In this case, the micro-heater and the gas sensor are provided right above the integrated circuit region. In the case of providing the micro-heater on the integrated circuit region, the thin film membrane for the micro-heater cannot be formed by bulk MEMS as described in the second embodiment. Therefore, it is necessary to form it using surface MEMS as described in the third embodiment.

Thus, a heater which is used for a sensor can be miniaturized by using a surface MEMS technology, and it is possible to achieve a sensor with low power consumption by reducing the heat capacity of the heater and by reducing the amount of thermal radiation from the heater portion. Moreover, the chip area can be drastically reduced by miniaturizing the heater.

### Fourth Embodiment

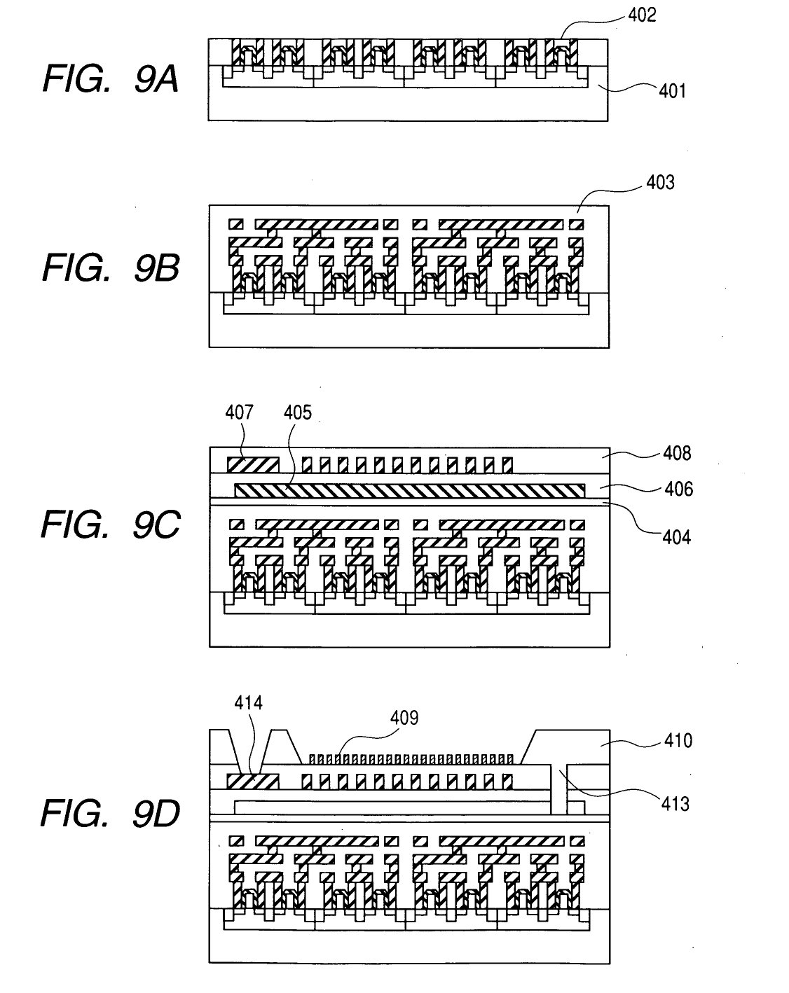

In this embodiment, using a surface MEMS technology described in the third embodiment a method will be described for integrating the sensor and an integrated circuit in the monolith. First of all, as shown in FIG. 9A, an integrated circuit transistor 402 is fabricated by using a conventional CMOS integrated circuit process in a predetermined region on a Si substrate 401. Next, as shown in FIG. 9B, a predetermined multi-layer inter-circuit 403 is formed to complete the integrated circuit portion. Next, as shown in FIG. 9C, after depositing the nitride film 404, a sacrificial layer film pattern 405 including the predetermined sensor region is formed on the above-mentioned nitride film, and a nitride film 406 is deposited once again on the above-mentioned sacrificial layer film pattern. Moreover, a heater circuit and a temperature sensor circuit 407 are formed on the above-mentioned silicon nitride using an appropriate metallic material, and it is embedded again by a nitride film 408.

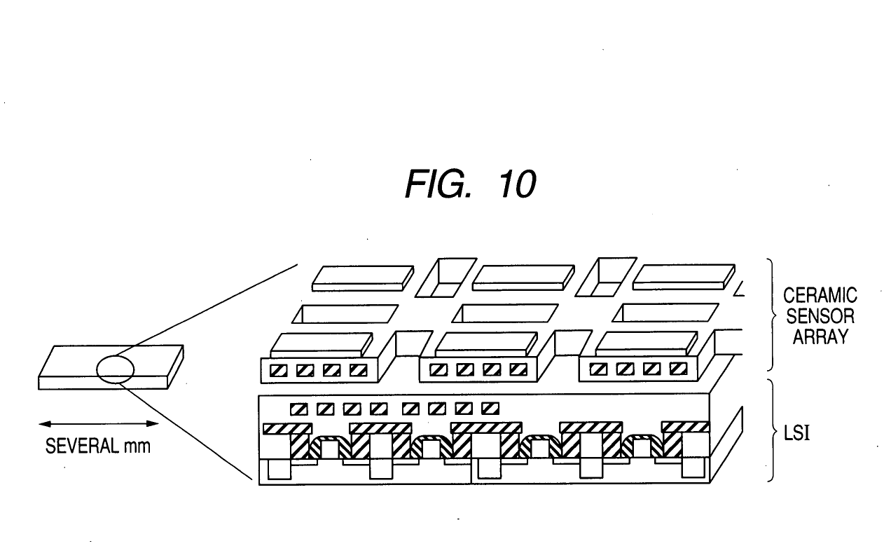

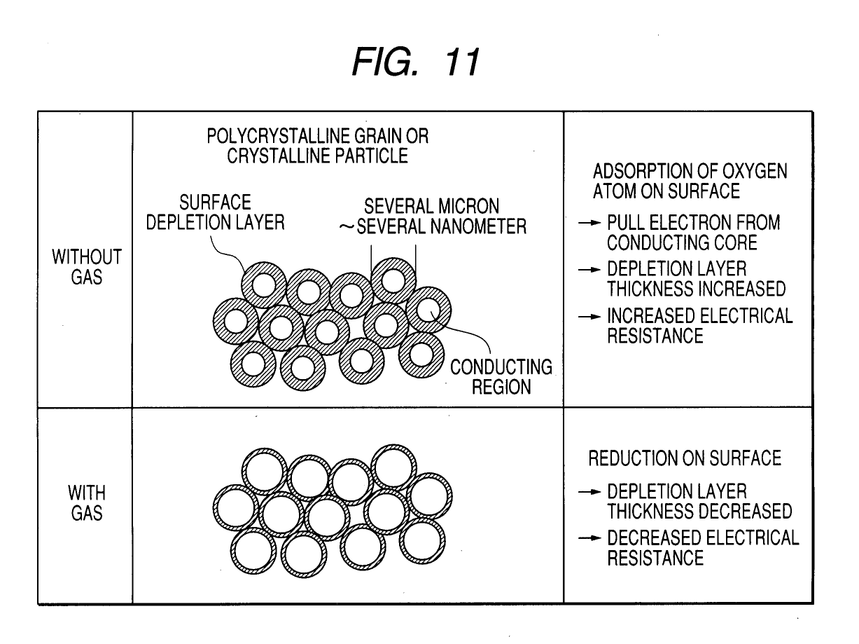

Next, as shown in FIG. 9D, a ceramic lattice pattern 409 is fabricated on the above-mentioned sensor region by using a means described in the first embodiment, and a Si oxide film and Si nitride film are deposited on the entire surface, if necessary to cover the above-mentioned ceramic lattice pattern. Afterwards, an aperture 410 passing through to the above-mentioned sacrificial layer film pattern from the surface of this substrate is formed, and a cavity 411 is formed by performing etching-removal on the above-mentioned sacrificial layer film through the above-mentioned aperture. Next, the above-mentioned cavity is passivated by forming a silicon oxide film using a CVD technique, and the above-mentioned oxide film on the ceramic pattern and the circuit pad (not shown in the figure) is removed. However, the passivation of the above-mentioned cavity is not necessary. The heat loss is slightly reduced if the cavity is made a vacuum. Finally, a pair of sensor electrodes is formed at the ends of the ceramic pattern. Moreover, a circuit is formed which connects the above-mentioned electrodes to a predetermined one selected from the above-mentioned pads, and the region except for the sensor is covered with a passivation film to complete this integrated gas sensor. FIG. 10 is a schematic bird's eyes view of a gas sensor integrated using a means of this embodiment. In FIG. 10, the gas sensors are arranged in the shape of an array. The ceramic film constituting each sensor has a different composition. Moreover, different catalysts are added depending on the requirements. Each sensor has a different sensitivity to different gaseous species, thereby, identification of the gaseous species becomes possible by the output of a plurality of sensors.

In this embodiment, the outputs from a plurality of sensors are input into an AD conversion circuit prepared as another chip and a micro-computer and a calculation is performed to determine the gaseous species. However, the above-mentioned determination may be done at the LSI portion shown in FIG. 10. In this case, the determination of the gas concentration and the species becomes possible by using only one chip. Moreover, forming a plurality of ceramic sensor films in the monolith on a substrate is effective not only in this embodiment, but also in the second and third embodiments.

Moreover, in this embodiment, curing the ceramic pattern of the sensor portion can be performed by scanning irradiation from a high intensity pulse laser. Although the temperature of the ceramic film becomes very high due to irradiation from the pulse laser, the heat transfer to the substrate portion is suppressed by rapid heat emission to the atmosphere after irradiation, so that the temperatures of the multi-layer inter-circuit and the LSI portion at the bottom the sensor are kept below 400° C. As a result, sensor characteristics of high performance and stability over time can be obtained in a ceramic sensor even if a ceramic sensor fabricated using a surface MEMS technology and an integrated circuit are formed in the monolith.

The industrial applicability of the present invention touches upon many areas such as a detecting system of various gases which are dangerous, harmful to or unpleasant for human body or which destroy the global environment in the environment surrounding a variety of industrial field and daily-life, controlling an automobile engine, and a diagnosis system for health condition of human body, etc.

What is claimed is:

1. A method for manufacturing a ceramic sensor comprising:
a process for forming a base film on a substrate,
a process for forming a pattern of the base film, which lies along a first direction and is arranged along a direction intersecting said first direction with a predetermined spacing, by etching said base film,
a process for pouring a ceramic precursor into the spaces of the pattern of the base film arranged with a predetermined spacing,
a process for making the ceramic precursor into ceramics by curing said ceramic precursor,
a process for forming a plurality of ceramic structures which lies along said first direction and is arranged along a direction intersecting said first direction by removing the pattern of said base film.

2. A method for manufacturing a ceramic sensor according to claim 1, further comprising:
a process for coating a resist over said base film,
a process for exposing the base film on which said resist is coated by using an alternating-type phase shifting mask,
wherein the pattern of said base film is formed by etching said exposed base film.

3. A method for manufacturing a ceramic sensor according to claim 2, wherein
said predetermined spacing is 100 nm or less.

4. A method for manufacturing a ceramic sensor according to claim 1, further comprising:
a process for forming a poly crystalline silicon film,
a process for coating a resist mask over said poly crystalline silicon film,
a process for forming a pattern of the poly crystalline silicon film, which lies along a first direction and is arranged along a direction intersecting said first direction with a predetermined spacing, by etching said poly crystalline silicon film,
wherein said base film is deposited on the upper layer of the poly crystalline silicon film arranged with said predetermined spacing, and the side walls of said base film are formed by etching said base film, thereby forming a pattern of said base film.

5. A method for manufacturing a ceramic sensor according to claim 4, wherein
said predetermined spacing of said poly crystalline silicon film is 100 nm or less, and said predetermined spacing of said base film is 30 nm or less.

6. A method for manufacturing a ceramic sensor according to claim 1, further comprising:
a process for forming a circuit having a transistor over a silicon substrate,
a process for forming wiring connected to said circuit.

7. A method for manufacturing a ceramic sensor according to claim 6, wherein
a process for forming said wiring is performed after a process for forming said ceramic structures.

8. A method for manufacturing a ceramic sensor according to claim 6, wherein
a process for forming said wiring is performed prior to a process for forming said ceramic structures.

9. A method for manufacturing a ceramic sensor according to claim 1, wherein
forming a pattern of said oxide film with a predetermined spacing does not allow grains of said ceramic precursor to grow in the direction intersecting said first direction.

10. A method for manufacturing a ceramic sensor according to claim 1, wherein
said base film is a silicon oxide film.

11. A ceramic sensor comprising:
a plurality of rectangular-shaped first ceramic structures which lie along a first direction and is arranged along a direction intersecting said first direction,
wherein said plurality of rectangular-shaped first ceramic structures is arranged having a predetermined spacing, and in each of said plurality of rectangular-shaped first ceramic structures, the width in a direction intersecting said first direction is smaller than the grain size of ceramics which are formed when said plurality of rectangular-shaped first ceramic structures is cured.

12. A ceramic sensor according to claim 11, wherein
in each of said plurality of rectangular-shaped first ceramic structures, the width in a direction intersecting said first direction is 100 nm or less.

13. A ceramic sensor according to claim 11, further comprising:
a transistor formed over a silicon substrate,
wherein said plurality of rectangular-shaped first ceramic structures is arranged in the upper part of said transistor.

14. A ceramic sensor according to claim 11, further comprising:
a plurality of rectangular-shaped second ceramic structures which lie along a direction intersecting said first direction and intersect said plurality of rectangular-shaped first ceramic structures.
